(19) United States
(12) Patent Application Publication
(10) Pub. No.: US 2008/0118833 A1
(43) Pub. Date: May 22, 2008

(54) Non-Aqueous Electrolyte Secondary Battery

(76) Inventors: Atsushi Ueda, Osaka (JP); Shoichiro Watanabe, Nara (JP); Takeshi Yao, Hyogo (JP); Takashi Takeuchi, Osaka (JP); Takayuki Shirane, Osaka (JP); Takaya Saito, Tochigi (JP); Hiromi Nagata, Osaka (JP)

Correspondence Address: MCDERMOTT WILL & EMERY LLP, 600 13TH STREET, NW, WASHINGTON, DC, 20005-3096, US

(21) Appl. No.: 11/667,110

(22) PCT Filed: Nov. 16, 2005
(86) PCT No.: PCT/JP05/21046

§ 371 Date: Nov. 21, 2007

(30) Foreign Application Priority Data
Nov. 19, 2004 (JP) 2004-335661

(51) Int. Cl. H01M 4/02; H01M 4/58; H01M 4/52; H01M 10/40

(52) U.S. Cl. 429/209; 429/231.8; 429/231.3; 429/231.6; 429/231.5; 429/223; 429/221; 429/231.2; 429/220; 429/229; 429/224; 429/326

(57) ABSTRACT

A non-aqueous electrolyte secondary battery includes a positive electrode that contains a lithium composite oxide as an active material. The cut-off voltage of charge is set to 4.25 to 4.5 V. In a region where the positive electrode and the negative electrode face each other, the Wp/Wn ratio R is in the range from 1.3 to 19 where Wp is the weight of the active material contained in the positive electrode per unit area and Wn is the weight of the active material contained in the negative electrode per unit area. This battery is excellent in safety, cycle characteristics, and storage characteristics even when the cut-off voltage of charge in a normal operating condition is set to 4.25 V or more.

### TECHNICAL FIELD

The present invention relates to non-aqueous electrolyte secondary batteries utilizing lithium ions, and, more particularly, to a high-voltage operable non-aqueous electrolyte secondary battery including a preferable positive electrode active material, and a battery charge/discharge system therefor.

### BACKGROUND ART

Non-aqueous electrolyte secondary batteries that have recently been used as the main power source for mobile communications devices and portable electronic devices are characterized by high electromotive force and high energy density. Positive electrode active materials used therein include lithium cobaltate (LiCoO₂) and lithium nickelate (LiNiO₂). These active materials have potentials of 4 V or more versus lithium (Li).

In lithium ion secondary batteries produced by utilizing these active materials, attempts have been made to heighten the operating voltage, since heightening the charge voltage of the battery results in a corresponding increase in capacity.

Lithium spinel oxides containing manganese (Mn), in particular, are stable even at high potential. Hence, it has been proposed to set the upper limit charge voltage in the range from 4.0 V to 4.5 V (e.g., see Patent Document 1).

Also, commonly used lithium composite cobalt oxides have high capacity, as well as excellent characteristics such as cycle characteristics and storage characteristics. However, they have poor thermal stability and suffer deterioration upon repeated charged/discharge at high voltage. Thus, in a normal operating condition, the cut-off voltage of charge is set to 4.2 V at most (4.25 V if errors of control circuit are included). If the voltage is higher than that, problems occur particularly in safety.

Even when the cut-off voltage of charge is set to 4.2 V, if the battery is overcharged, for example, by accident, the battery voltage may rise. Hence, in order to stably maintain the crystal structure of a positive electrode active material even in an overcharged condition, there has been proposed a technique of preparing a solid solution of a composite oxide with specific elements dissolved therein (e.g., see Patent Document 2). Also, there has been another proposal to mix specific two kinds of active materials to enhance the thermal stability of the battery in an overcharged condition (e.g., see Patent Document 3).

### Patent Document 1: Japanese Laid-Open Patent Publication No. 2001-307781

### Patent Document 2: Japanese Laid-Open Patent Publication No. 2002-203553

### Patent Document 3: Japanese Laid-Open Patent Publication No. 2002-319398

### DISCLOSURE OF INVENTION

### Problem that the Invention is to Solve

When the cut-off voltage of charge in a normal operating condition is set to 4.25 V or more, the utilization of the positive electrode, i.e., capacity, increases, but the load of the negative electrode is constant. Thus, the application of a conventional 4.2 V-based battery design causes the balance of battery capacity to be lost.

The present invention solves this problem and intends to provide a high capacity non-aqueous electrolyte secondary battery that operates normally in terms of battery functions such as safety, cycle characteristics, heat resistance, and storage characteristics even when the cut-off voltage of charge in a normal operating condition is set to 4.25 V or more.

### Means for Solving the Problem

When the cut-off voltage of charge in a normal operating condition is set to various values of 4.25 V or more with the weights of the positive and negative electrodes set to conventional certain values, the capacity balance between the positive and negative electrodes is lost, thereby resulting in poor characteristics. In order to keep the capacity balance of the battery, it is effective to decrease the weight of the positive electrode and increase the weight of the negative electrode. Further, depending on where in the electrode plate the positive/negative electrode active material is located, there is a difference in the load (capacity per weight) between the location where the electrodes face each other and the location where they do not.

In view of the above, the present invention relates to a non-aqueous electrolyte secondary battery including a positive electrode that contains a lithium composite oxide as an active material. The battery has a cut-off voltage of charge of 4.25 to 4.5 V. In a region where the positive electrode and the negative electrode face each other, the weight ratio R between the active materials contained in the positive electrode and the negative electrode per unit area is set to a specific value.

Specifically, the non-aqueous electrolyte secondary battery of the present invention includes: a negative electrode including an active material capable of absorbing and desorbing lithium; a positive electrode including a lithium composite oxide as an active material; a separator separating the negative electrode and the positive electrode; and a lithium-ion conductive non-aqueous electrolyte. The cut-off voltage of charge is set to 4.25 to 4.5 V. In a region where the positive electrode and the negative electrode face each other, the Wp/Wn ratio R is in the range from 1.3 to 19 where Wp is the weight of the active material contained in the positive electrode per unit area and Wn is the weight of the active material contained in the negative electrode per unit area.

### BRIEF DESCRIPTION OF DRAWINGS

FIG. 1 is a perspective cutaway view of the main part of a non-aqueous electrolyte battery in an Example of the present invention; and

FIG. 2 is a block diagram showing the structure of a charge/discharge control unit including a battery of the present invention.

### BEST MODE FOR CARRYING OUT THE INVENTION

The non-aqueous electrolyte secondary battery according to the present invention includes a negative electrode including an active material capable of absorbing and desorbing lithium; a positive electrode including a lithium composite oxide as an active material; a separator separating the negative electrode and the positive electrode; and a lithium-ion conductive non-aqueous electrolyte. The cut-off voltage of charge is set to 4.25 to 4.5 V.

Even when the cut-off voltage of charge in a normal operating condition is set in the range from 4.25 to 4.5 V, the non-aqueous electrolyte secondary battery of the present invention offers sufficient safety and operates normally.

As used therein, “a normal operating condition” refers to a condition in which a non-aqueous electrolyte secondary battery operates normally, and it is also an operating condition recommended by the manufacturer of the battery.

Also, the “cut-off voltage of charge” refers to a reference voltage for stopping a constant current charge of a battery, and when the voltage of the battery being charged reaches the reference voltage, the constant current charge of the battery is stopped. Thereafter, while maintaining this reference voltage, a constant voltage charge is usually performed. The constant voltage charge is stopped either after the passage of a predetermined period of time or when the current value decreases to a predetermined value or less. The cut-off voltage of charge is determined in advance depending on the design of the non-aqueous electrolyte secondary battery.

Generally, the cut-off voltage of charge in a normal operating condition is the upper limit voltage of a battery voltage range that is preferable or recommended for operating a non-aqueous electrolyte secondary battery normally.

In the non-aqueous electrolyte secondary battery of the present invention, in the region where the positive electrode and the negative electrode face each other, the Wp/Wn ratio is in the range from 1.3 to 19 where Wp is the weight of the active material contained in the positive electrode per unit area and Wn is the weight of the active material contained in the negative electrode per unit area (this ratio is hereinafter referred to as simply the positive/negative active material weight ratio R). This ensures the load balance between the positive and negative electrodes and provides high capacity and excellent reliability. Although the weight ratio R can be converted to capacity ratio, weight ratio is easier to understand and more clear, since active materials are weighed to prepare electrode mixtures in an actual production process of batteries.

In a preferable embodiment of the present invention, the active material of the negative electrode is composed mainly of a carbonaceous substance capable of absorbing and desorbing lithium, and the weight ratio R is in the range from 1.3 to 2.2, and more preferably in the range from 1.7 to 2.0.

In another preferable embodiment of the present invention, the active material of the negative electrode is composed mainly of an alloy or metal compound capable of absorbing and desorbing lithium, and the weight ratio R is in the range from 2.5 to 19.

According to the above-mentioned embodiments, even when the cut-off voltage of charge in a normal operating condition is set to 4.25 V or more, it is possible to provide a high capacity non-aqueous electrolyte secondary battery that operates normally in terms of battery functions such as cycle characteristics, heat resistance, and storage characteristics, as well as safety.

When the battery whose negative electrode active material is composed mainly of a carbonaceous substance capable of absorbing and desorbing lithium has a weight ratio R of less than 1.3, or when the battery whose negative electrode active material is composed mainly of an alloy or metal compound capable of absorbing and desorbing lithium has a weight ratio R of less than 2.5, the weight of the negative electrode is excessive relative to the positive electrode. Thus, when the battery is placed in a high temperature condition, the thermal stability of the battery decreases. Also, when the battery whose negative electrode active material is composed mainly of such a carbonaceous substance has a weight ratio R of greater than 2.2, or when the battery whose negative electrode active material is composed mainly of such an alloy or metal compound has a weight ratio R of greater than 19, the load of the negative electrode is excessive relative to the load of the positive electrode. Hence, when the battery is repeatedly cycled, lithium metal may be deposited on the negative electrode, thereby resulting in deterioration of battery reliability.

In a preferable embodiment of the present invention, the positive electrode active material is a lithium composite oxide represented by the following formula (1):

LiₓCo_{1-y}M_{y}O₂ (1)

where M is at least one element selected from the group consisting of Mg, Al, Ti, Sr, Mn, Ni, Ca, V, Fe, Y, Zr, Mo, Tc, Ru, Ta, W, Re, Yb, Cu, Zn, and Ba, 1.0≦x≦1.15, and 0.005≦y≦0.1.

When the negative electrode active material is composed mainly of a carbonaceous substance capable of absorbing and desorbing lithium, the positive/negative active material weight ratio R is preferably in the range from 1.5 to 2.2. When the negative electrode active material is composed mainly of an alloy or metal compound capable of absorbing and desorbing lithium, the positive/negative active material weight ratio R is preferably in the range from 3.0 to 19.

In another preferable embodiment of the present invention, the positive electrode active material is a lithium composite oxide represented by the following formula (2):

LiₓNi_{y}Mn_{z}M_{1-y-z}O₂ (2)

where M is at least one element selected from the group consisting of Co, Mg, Al, Ti, Sr, Ca, V, Fe, Y, Zr, Mo, Tc, Ru, Ta, W, and Re, 1.0≦x≦1.15, 0.1≦y≦0.5, 0.1≦z≦0.5, and 0.9≦y/z≦3.0.

When the negative electrode active material is composed mainly of a carbonaceous substance capable of absorbing and desorbing lithium, the positive/negative active material weight ratio R is preferably in the range from 1.3 to 2.0. When the negative electrode active material is composed mainly of an alloy or metal compound capable of absorbing and desorbing lithium, the positive/negative active material weight ratio R is preferably in the range from 2.5 to 18.

In still another preferable embodiment of the present invention, the positive electrode active material is a mixture of an oxide A represented by the formula (1) and an oxide B represented by the formula (2) in a predetermined ratio.

When the negative electrode active material is composed mainly of a carbonaceous substance capable of absorbing and desorbing lithium, the positive/negative active material weight ratio R is preferably in the range from 1.3 to 2.2. When the negative electrode active material is composed mainly of an alloy or metal compound capable of absorbing and desorbing lithium, the positive/negative active material weight ratio R is preferably in the range from 2.5 to 19.

The alloy or metal compound capable of absorbing and desorbing lithium is preferably at least one selected from the group consisting of Si, Sn, an alloy containing Si or Sn, and SiO, since they can offer high capacity.

The mixing weight ratio of the positive electrode active material A to the positive electrode active material B is preferably from 9:1 to 1:9, and more preferably from 9:1 to 5:5. The electronic conductivity of the positive electrode active material A and the high capacity of the positive electrode active material B can produce a complementary effect, thereby making it possible to realize a battery having higher capacity and excellent discharge characteristics at low temperatures.

The surface of the positive electrode active material of the present invention is preferably coated with at least one metal selected from the group consisting of Mg, Al, Ti, Sr, Mn, Ni, Ca, V, Fe, Y, Zr, Mo, Tc, Ru, Ta, W, Re, Sn, Bi, Cu, Si, Ga, and B, an intermetallic compound containing the metal, or an oxide of the metal. This produces the effect of suppressing dissolution of metal from the positive electrode active material in a high-voltage charged state in a high voltage battery whose cut-off voltage of charge in a normal operating condition is set to 4.25 to 4.5 V. As a result, the positive electrode active material is prevented from deteriorating due to charge/discharge cycles, so that the capacity retention rate is improved.

In still another preferable embodiment of the present invention, in addition to any one of the above-mentioned positive electrode active materials, the positive electrode includes an oxide represented by the formula (3):

MOₓ (3)

where M is at least one element selected from the group consisting of Li, Co, Mg, Al, Ti, Sr, Mn, Ni, Ca, V, Fe, Y, Zr, Mo, Tc, Ru, Ta, W, and Re, and 0.4≦x≦2.0.

This embodiment has the effect of suppressing dissolution of metal from the positive electrode active material in a high-voltage charged state. As a result, the positive electrode active material is prevented from deteriorating due to charge/discharge cycles, so that the capacity retention rate is improved.

In still another preferable embodiment of the present invention, the non-aqueous electrolyte contains a cyclic carbonate and a non-cyclic carbonate as solvents. The cyclic carbonate forms a good coating film on the surface of the negative electrode, thereby suppressing the decomposition of the electrolyte. Also, the non-cyclic carbonate decreases the viscosity of the electrolyte, thereby promoting the penetration of the electrolyte into the electrode plates.

The cyclic carbonate in the electrolyte is preferably 10 to 50% by volume at 20° C. If it is less than 10%, the formation of a good coating film on the surface of the negative electrode decreases, so that the reactivity between the negative electrode and the electrolyte increases, thereby promoting the decomposition of the electrolyte. If it is greater than 50%, the viscosity of the electrolyte increases, thereby interfering with the penetration of the electrolyte into the electrode plates.

In another preferable embodiment of the present invention, the non-aqueous electrolyte contains LiPF₆ as a lithium salt. In a more preferable embodiment, it contains 0.5 to 2.0 mol/l of LiPF₆ and 0.01 to 0.3 mol/l of LiBF₄. If the LiPF₆ concentration is lower than 0.5 mol/l, LiPF₆ is decomposed with increasing cycles, so that normal discharge becomes impossible due to shortage of the lithium salt. If the LiPF₆ concentration is higher than 2.0 mol/l, the viscosity of the electrolyte increases, thereby interfering with smooth penetration of the electrolyte into the electrode plates. Since LiBF₄ suppresses the decomposition of the electrolyte during cycling, it has the effect of improving cycle characteristics. If the LiBF₄ concentration is lower than 0.01 mol/l, a sufficient improvement in cycle characteristics cannot be obtained. If it is higher than 0.3 mol/l, decomposition products of LiBF₄ interfere with the movement of lithium ions, thereby causing a degradation of discharge characteristics.

In still another preferable embodiment of the present invention, the non-aqueous electrolyte contains, as an additive, at least one of benzene derivatives including a group that contains a phenyl group and tertiary or quaternary carbon adjacent to the phenyl group. The additive has the effect of suppressing heat runaway when the battery is overcharged.

The additive is preferably at least one selected from the group consisting of cyclohexyl benzene, biphenyl, and diphenyl ether. The content of the additive is preferably 0.05 to 8.0% by weight of the whole non-aqueous electrolyte, and more preferably 0.1 to 6.0% by weight. If the content of the additive is less than the above-mentioned range, heat runaway is not prevented upon overcharge. Also, if the content of the additive is greater than the above-mentioned range, the excessive additive interferes with the movement of lithium ions, thereby causing a degradation of discharge characteristics.

The negative electrode active material of the present invention is a carbonaceous substance, alloy, or metal compound capable of absorbing and desorbing lithium, and any conventionally known one can be used. Examples of carbonaceous substances include: thermally decomposed carbons; cokes such as pitch coke, needle coke, and petroleum coke; graphites and glassy carbons; baked organic polymer compounds, for example, polymer compounds, such as phenolic resin and furan resin, which are carbonized by baking at suitable temperatures; and carbon materials such as carbon fibers and activated carbon. The alloy preferably comprises at least one selected from the group consisting of Si, Sn, Al, Zn, Mg, Ti, and Ni. The metal compound is at least one selected from the group consisting of an oxide of the above-mentioned metal and a carbide of the above-mentioned metal. At least one selected from the group consisting of Si, Sn, an alloy containing Si or Sn, and SiO is more preferable. These materials can be used singly or in combination of two or more of them. The mean particle size of these negative electrode active materials is not particularly limited, but is preferably 1 to 30 μm.

The binder for use in the negative electrode is a thermoplastic resin, a thermosetting resin, or the like. Such examples include polyethylene, polypropylene, polytetrafluoroethylene, polyvinylidene fluoride, styrene butadiene rubber, tetrafluoroethylene-hexafluoropropylene copolymer, tetrafluoroethylene-perfluoroalkylvinylether copolymer, vinylidene fluoride-hexafluoropropylene copolymer, vinylidene fluoride-chlorotrifluoroethylene copolymer, ethylene-tetrafluoroethylene copolymer, polychlorotrifluoroethylene, vinylidene fluoride-pentafluoropropylene copolymer, propylene-tetrafluoroethylene copolymer, ethylene-chlorotrifluoroethylene copolymer, vinylidene fluoride-hexafluoropropylene-tetrafluoroethylene copolymer, vinylidene fluoride-perfluoromethylvinylether-tetrafluoroethylene copolymer, ethylene-acrylic acid copolymer or (Na⁺)ion crosslinked material thereof, ethylene-methacrylic acid copolymer or (Na⁺)ion crosslinked material thereof, ethylene-methyl acrylate copolymer or (Na⁺)ion crosslinked material thereof, and ethylene-methyl methacrylate copolymer or (Na⁺)ion crosslinked material thereof. These materials can be used singly or as a mixture. Among these materials, particularly preferred are styrene butadiene rubber, polyvinylidene fluoride, ethylene-acrylic acid copolymer or (Na⁺)ion crosslinked material thereof, ethylene-methacrylic acid copolymer or (Na⁺)ion crosslinked material thereof, ethylene-methyl acrylate copolymer or (Na⁺)ion crosslinked material thereof, and ethylene-methyl methacrylate copolymer or (Na⁺)ion crosslinked material thereof.

The conductive agent for use in the negative electrode may be any electronically conductive material. Examples include: graphites such as natural graphite including flake graphite, artificial graphite and expanded graphite; carbon blacks such as acetylene black, ketjen black, channel black, furnace black, lamp black, and thermal black; conductive fibers such as carbon fiber and metal fiber; metal powders such as copper and nickel and organic conductive materials such as polyphenylene derivatives. They may be used singly or as a mixture. Among these conductive agents, artificial graphite, acetylene black, and carbon fibers are particularly preferred. The amount of the conductive agent is not particularly limited, but is preferably 1 to 30 parts by weight per 100 parts by weight of the negative electrode active material, and more preferably 1 to 10 parts by weight.

The current collector for use in the negative electrode may be any electron conductor that is substantially chemically stable in a produced battery. Examples of such materials include stainless steel, nickel, copper, titanium, carbon, conductive resin, and composite materials obtained by treating the surface of copper or stainless steel with carbon, nickel or titanium. Among them, copper and copper alloys are particularly preferred. The surface of these materials may be oxidized before use. Also, it is preferable to apply a surface treatment to the current collector to make the surface irregular. The current collector may be in the form of foil, film, sheet, net, lath, foam, or molded fiber, or may be punched or porous. The thickness is not particularly limited, but is preferably 1 to 500 μm.

The lithium-ion conductive non-aqueous electrolyte is composed of a solvent, a lithium salt dissolved in the solvent, and, if necessary, an additive. The non-aqueous solvent may be any known material. Among them, a preferable example is a mixture of a cyclic carbonate, such as ethylene carbonate or propylene carbonate, and a non-cyclic carbonate, such as dimethyl carbonate, diethyl carbonate, ethyl methyl carbonate, dipropyl carbonate, or dibutyl carbonate. Further, the cyclic carbonate is preferably 10 to 50% by volume of the whole solvents. Also, the lithium salt is not particularly limited in the present invention, and may be any conventional one used in non-aqueous electrolyte secondary batteries, such as LiClO₄, LiAsF₆, LiPF₆, LiBF₄, LiCF₃SO₃, LiN(CF₃SO₂)₂, LiN(C₂F₅SO₂)₂, LiN(CF₃SO₂)(C₄F₉SO₂), or LiB[C₆F₃(CF₃)₂]₄. It is particularly preferable to use LiPF₆ in the range from 0.5 to 2.0 mol/l, and it is more preferable to use LiPF₆ and LiBF₄ in the range from 0.5 to 2.0 mol/l and the range from 0.01 to 0.3 mol/l, respectively. In this way, the non-aqueous electrolyte used in the present invention is not particularly limited, and may be any conventional one used in non-aqueous electrolyte secondary batteries. Also, a mixture of two or more kinds of these electrolytes may be used. The additive may be a known cyclic carbonate having unsaturated bond, such as vinylene carbonate, vinyl ethylene carbonate, or divinyl ethylene carbonate; a benzene derivative including a group that contains a phenyl group and tertiary or quaternary carbon adjacent to the phenyl group, such as cyclohexyl benzene, biphenyl, or diphenyl ether; a sulfur-containing organic compound such as propanesultone. These additives may be used singly or in combination of two or more of them. The additive is preferably 0.05 to 8.0% by weight of the whole non-aqueous electrolyte, and more preferably 0.1 to 6.0%.

The separator used in the present invention is an insulating microporous thin film with high ion-permeability and predetermined mechanical strength. It preferably has the function of closing its pores when the temperature reaches a certain level in order to provide increased resistance. The pore size of the separator is desirably such that the positive and negative electrode materials, binder, and conductive agent that have separated from the electrodes do not pass through the pores, and, for example, 0.01 to 1 μm is desirable. The thickness of the separator may be 10 to 300 μm. Also, the porosity is determined in view of electron or ion permeability, material, and the thickness of the separator, and generally, it is preferably 30 to 80%. Also, the separator may be a polymer material impregnated with an organic electrolyte composed of a solvent and a lithium salt dissolved in the solvent. The polymer material impregnated with the organic electrolyte may also be added to a positive electrode mixture or a negative electrode mixture so as to be integrated with the positive electrode and/or the negative electrode. The polymer material may be any material capable of absorbing and retaining the organic electrolyte, but polyvinylidene fluoride is particularly preferable.

The positive electrode active material used in the present invention is a lithium composite oxide, and a particularly preferred lithium composite oxide is one in which part of the constituent metal elements is replaced with a third or fourth metal element (hereinafter referred to as a different metal element). A lithium composite oxide to which no different metal element is added, for example, lithium cobaltate, undergoes a phase change from the hexagonal system to the monoclinic system when the battery is charged to a voltage of about 4.2 V (the positive electrode potential is about 4.25 V verses Li metal) to 4.45 V. When the battery is further charged, then the composite oxide changes to the hexagonal system and, at about 4.6 V, again changes to the monoclinic system. The monoclinic crystal structure appears when the whole crystal is distorted. Thus, it is known that a monoclinic composite oxide has a weak bonding between the oxygen ion, which plays a central role in maintaining the crystal structure, and the metal ion present around it and that the composite oxide has a significantly low heat resistance.

According to the present invention, by adding a small amount of different metal to a lithium composite oxide, the crystal stability is enhanced and normal operation is ensured even when the battery voltage is set to a high level.

In a preferable embodiment of the present invention, a lithium composite oxide to which different metal is added is an oxide represented by the above-mentioned formula (1). The value x in the formula changes when the battery is charged or discharged.

With respect to the composition of the oxide right after the synthesis thereof, preferably 1.0≦x≦1.15 in the formula. If x is 1.0 or more, the occurrence of lithium shortage can be suppressed. In order to enhance the structural stability of the oxide as the active material, it is particularly preferred that x be 1.01 or more.

On the other hand, if x is less than 1, lithium necessary for synthesizing a high performance active material becomes insufficient. That is, the amount of by-products such as Co₃O₄ contained in the active material increases, thereby resulting in production of CO₃O₄-derived gas inside the battery, a capacity loss, etc.

In the formula, M is an element necessary for stabilizing crystal, as described above. Among the elements listed in the formula (1), it is particularly preferable to use at least one selected from the group consisting of Mg, Al, Ti, Mn, Ni, Zr, Mo, and W. When the surface of the active material is coated with an oxide of such a particularly preferable element M or a composite oxide of lithium and M, it is stabilized. As a result, even at a high potential, the decomposition reaction of the non-aqueous electrolyte and the crystal destruction of the positive electrode active material are suppressed. To obtain the stabilization effect of the element M, at least 0.005≦y. If 0.1<y, the capacity of the active material decreases, which poses a problem.

Among the above-described positive electrode active materials, it is preferable to use oxides represented by the formula LiₓCo_{1-y-z}Mg_{y}Al_{z}O₂ where 1.0≦x≦1.02, 0.005≦y≦0.1, and 0.001≦z<0.05. The thermal stability of a positive electrode including such an oxide remains almost unchanged even when the potential becomes 4.8 V versus lithium, as compared with 4.2 V.

The mechanism can be as follows, although its details are not yet clear.

That is, by replacing part of the Co with a preferable amount of Mg, the crystal stability is enhanced when Li is released from the crystal due to charge, and elimination of oxygen or the like does not occur. In another aspect, the mechanism is probably as follows. The above-mentioned oxide has high electronic conductivity and serves as a kind of conductive agent, thereby forming a uniform potential distribution in the positive electrode. As a result, the amount of Co having a higher voltage than that of the surroundings decreases relatively, thereby suppressing the deterioration of thermal stability.

If x is less than 1, oxides of metal such as Co are likely to be formed as impurities, thereby causing a problem such as production of gas during charge/discharge cycles. Also, if y, which represents the amount of Mg substituted, is less than 0.005, the above-mentioned effect cannot be obtained. If it is greater than 0.1, the capacity decreases.

Meanwhile, Al has the effect of enhancing the Mg's function of stabilizing the structure and improving the heat resistance, although the reason is not clear. However, the amount of Al substituted is preferably less, and if it is 0.05 or more, the capacity decreases. It should be noted that the effect of the present invention can be obtained if it is 0.001 or more.

In another preferable embodiment of the present invention, a lithium composite oxide to which different metal is added is an oxide represented by the above-mentioned formula (2). The value x changes when the battery is charged or discharged.

With respect to the composition of the oxide right after the synthesis thereof, preferably 1.0≦x≦1.15. If x is 1.0 or more, the occurrence of lithium shortage can be suppressed. In order to enhance the structural stability of the oxide as the active material, it is particularly preferred that x be 1.01 or more. On the other hand, if x is less than 1, lithium necessary for synthesizing a high performance active material becomes insufficient. That is, the amount of by-products contained in the active material increases, thereby resulting in production of gas inside the battery, a capacity loss, etc.

When 0.1≦y≦0.5, 0.1≦z≦0.5, and 0.9≦y/z≦3.0 where y represents the amount of Ni and z represents the amount of Mn, the addition of the element M provides stability even at a high voltage.

A lithium composite oxide represented by the formula (1) or the formula (2), which is used as a positive electrode active material of the present invention, can be prepared by mixing raw material compounds corresponding to the composition of the respective metal elements of the composite oxide in an oxidizing atmosphere and baking them. The raw material compounds may be oxides, hydroxides, oxyhydroxides, carbonates, nitrates, organic complex salts, etc. of the respective metal elements of the composite oxide, and they may be used singly or in combination of two or more of them. In order to facilitate the synthesis of the lithium composite oxide, it is preferable to use solid solutions of oxides, hydroxides, oxyhydroxides, carbonates, nitrates, organic complex salts, etc. of the respective metal elements.

The oxidizing atmosphere and baking temperature for synthesizing a lithium composite oxide depend on the composition, the amount of synthesis, and the synthesizing apparatus and, thus, are preferably determined in consideration of them. Idealistically, the lithium composite oxide should be composed of a single phase, but the lithium composite oxide may be an industrially mass-produced, multi-phase mixture including slight amounts of other phases. Also, it may contain other elements than the above-mentioned ones as impurities as long as the amounts thereof are within the amounts usually contained in industrial raw materials. The mean particle size of the positive electrode active material is not particularly limited, but is preferably 1 to 30 μm.

The conductive agent for use in the positive electrode may be any electronically conductive material that is substantially chemically stable in a produced battery. Examples include graphites such as natural graphite including flake graphite, and artificial graphite; carbon blacks such as acetylene black, ketjen black, channel black, furnace black, lamp black, and thermal black; conductive fibers such as carbon fiber and metal fiber; carbon fluoride; metal powders such as aluminum and conductive whiskers such as zinc oxide and potassium titanate; and conductive metal oxides such as titanium oxide, or organic conductive materials such as polyphenylene derivatives. They may be used singly or as a mixture. Among these conductive agents, artificial graphite and acetylene black are particularly preferred. The amount of the conductive agent is not particularly limited, but is preferably 1 to 50 parts by weight per 100 parts by weight of the positive electrode active material, and more preferably 1 to 30 parts by weight. In the case of carbon and graphite, 1 to 15 parts by weight is particularly preferred.

The binder for use in the positive electrode may be a thermoplastic resin, a thermosetting resin, or the like. Examples include polyethylene, polypropylene, polytetrafluoroethylene, polyvinylidene fluoride, styrene butadiene rubber, tetrafluoroethylene-hexafluoropropylene copolymer, tetrafluoroethylene-perfluoroalkylvinylether copolymer, vinylidene fluoride-hexafluoropropylene copolymer, vinylidene fluoride-chlorotrifluoroethylene copolymer, ethylene-tetrafluoroethylene copolymer (ETFE resin), polychlorotrifluoroethylene (PCTFE), vinylidene fluoride-pentafluoropropylene copolymer, propylene-tetrafluoroethylene copolymer, ethylene-chlorotrifluoroethylene copolymer, vinylidene fluoride-hexafluoropropylene-tetrafluoroethylene copolymer, vinylidene fluoride-perfluoromethylvinylether-tetrafluoroethylene copolymer, ethylene-acrylic acid copolymer or (Na⁺)ion crosslinked material thereof, ethylene-methacrylic acid copolymer or (Na⁺)ion crosslinked material thereof, ethylene-methyl acrylate copolymer or (Na⁺) ion crosslinked material thereof, and ethylene-methyl methacrylate copolymer or (Na⁺)ion crosslinked material thereof. These materials may be used singly or as a mixture. Also, among these materials, polyvinylidene fluoride and polytetrafluoroethylene are particularly preferred.

The current collector for use in the positive electrode may be any electron conductor that is substantially chemically stable in a produced battery. Examples of such materials include aluminum, stainless steel, nickel, titanium, carbon, conductive resin, and composite materials obtained by coating the surface of aluminum or stainless steel with carbon or titanium. Among them, aluminum and aluminum alloys are particularly preferred. The surface of these materials may be oxidized before use. Also, it is preferable to apply a surface treatment to the current collector to make the surface irregular.

The positive electrode current collector may be in the form of foil, film, sheet, net, lath, foam, or molded fiber, or may be punched or porous. The thickness is not particularly limited, but is preferably 1 to 500 μm.

The positive electrode mixture and the negative electrode mixture may contain various additives such as filler, dispersing agent, ion conductor, and pressure-resistant material in addition to the above-mentioned conductive agent and binder. The filler may be any fibrous material that is chemically stable in a produced battery. Typically, olefin polymers such as polypropylene and polyethylene, glass fiber, and carbon fiber are used. The amount of the filler is not particularly limited, but is preferably 0 to 10 parts by weight per 100 parts by weight of the positive electrode mixture and the negative electrode mixture.

The non-aqueous electrolyte secondary battery of the present invention is used as the power source for such devices as cellular phones and personal computers, in combination with a charge control unit that controls the cut-off voltage of charge at a set voltage in the range from 4.25 to 4.5 V.

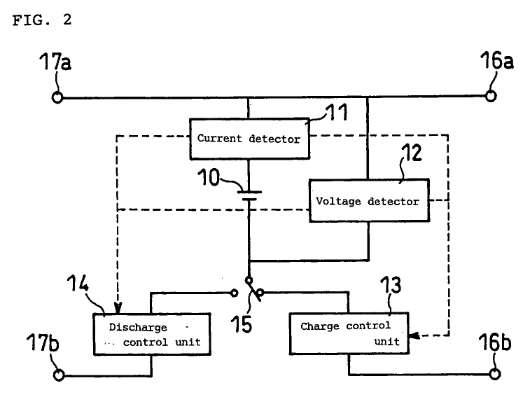

FIG. 2 is a block diagram showing the structure of such a charge control unit. The control unit also includes a discharge control unit.

Reference number 10 represents a non-aqueous electrolyte secondary battery according to the present invention. A current detector 11 is connected in series to the battery 10. A voltage detector 12 is connected in parallel to the circuit in which the battery 10 and the current detector 11 are connected in series. Reference characters 16a and 16b are input terminals for charging the battery 10, while reference characters 17a and 17b are output terminals for connecting to a device. A switch 15 is provided in series with the battery 10. For charge, the switch 15 is switched so as to connect to a charge control unit 13. For discharge, it is switched so as to connect to a discharge control unit 14.

Examples of the present invention are hereinafter described.

### EXAMPLE 1

### Battery Production

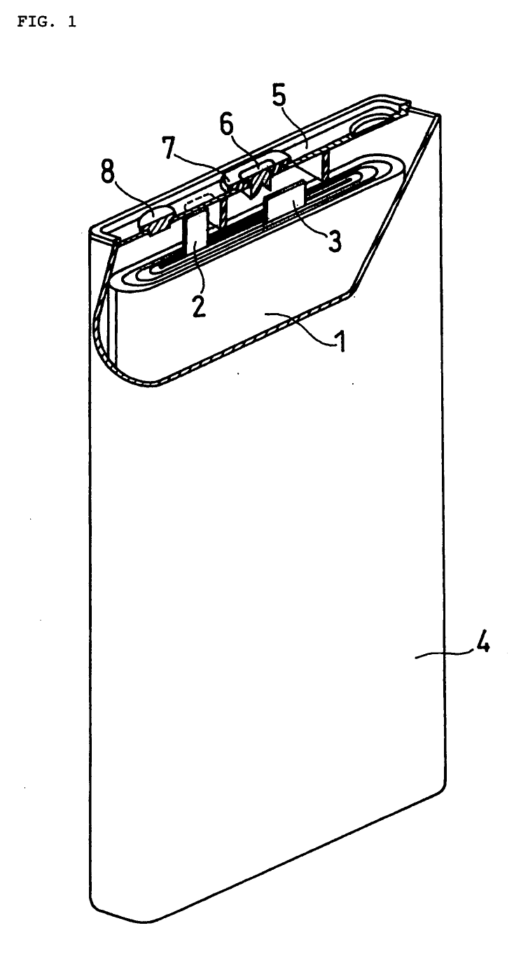

FIG. 1 illustrates a prismatic non-aqueous electrolyte secondary battery used in this example, with a thickness of 5.2 mm, a width of 34 mm, and a height of 50 mm. An electrode plate group 1 is prepared by spirally winding a belt-like positive electrode plate, a belt-like negative electrode plate, and a separator interposed between them. The positive electrode plate and the negative electrode plate are welded with an aluminum positive electrode lead 2 and a nickel negative electrode lead 3, respectively. The electrode plate group 1, with an insulating ring made of polyethylene resin fitted to the upper part thereof, is housed in an aluminum battery case 4. The end of the positive electrode lead 2 is spot welded to an aluminum sealing plate 5. Also, the end of the negative electrode lead 3 is spot welded to the lower part of a nickel negative electrode terminal 6, which is attached to the central part of the sealing plate 5 with an insulating gasket 7 interposed therebetween. The opening of the battery case 4 is laser welded to the sealing plate 5 so as to seal out gas and liquid. A predetermined amount of a non-aqueous electrolyte is injected therein from a liquid inlet of the sealing plate. Thereafter, the liquid inlet is sealed by laser welding an aluminum cap 8 thereto.

The positive electrode was prepared as follows.

First, LiCo_{0.94}Mg_{0.05}Al_{0.01}O₂ was used as the positive electrode active material. 100 parts by weight of this positive electrode active material was mixed with 3 parts by weight of acetylene black serving as a conductive agent and an N-methyl-pyrrolidinone solution of polyvinylidene fluoride containing 5 parts by weight of polyvinylidene fluoride as a binder. The resulting mixture was stirred to form a positive electrode mixture paste. Next, the positive electrode mixture paste was applied onto both sides of a 20-μm-thick current collector made of aluminum foil, dried, rolled with reduction rollers, and cut to predetermined dimensions, to obtain a positive electrode plate. The amount of the active material contained in the positive electrode plate on one side of the current collector was 22.8 mg/cm² per unit area.

The negative electrode was prepared as follows.

First, flake graphite which had been crushed and classified to provide a mean particle size of approximately 20 μm was mixed with 3 parts by weight of styrene-butadiene rubber serving as a binder. Thereafter, a carboxymethyl cellulose aqueous solution was added thereto such that the carboxymethyl cellulose was 1% by weight of the graphite. The resulting mixture was stirred to form a negative electrode mixture paste. The negative electrode mixture paste was applied onto both sides of a 15-μm-thick current collector made of copper foil, dried, rolled with reduction rollers, and cut to predetermined dimensions, to obtain a negative electrode plate. The amount of the active material contained in the negative electrode plate on one side of the current collector facing the positive electrode was 11.4 mg/cm² per unit area.

It is common to make the area of the negative electrode plate larger than that of the positive electrode plate and dispose the negative electrode plate so as to face the positive electrode. In the area of the negative electrode not facing the positive electrode, the negative electrode active material does not contribute to charge/discharge reactions. Not in the area not contributing to charge/discharge, but in the charge/discharge area where the two electrodes face each other, the present invention defines the amounts of the positive electrode active material and the negative electrode active material on one side of the current collector per unit area.

Next, the belt-like positive and negative electrode plates prepared in the above manner and a 25-μm-thick microporous polyethylene resin separator interposed between the two electrodes were spirally wound together. The positive/negative active material weight ratio R was 2.0.

The non-aqueous electrolyte was prepared by dissolving LiPF₆ at 1.0 mol/l in a solvent mixture of ethylene carbonate and ethyl methyl carbonate in a volume ratio of 30:70 at 20° C.

The wound electrode plate group was inserted into a battery case, into which an electrolyte was injected. The battery case was then sealed. The battery thus produced was designated as a battery 6 of Example 1.

Further, batteries 1 to 5 and 7 to 9 were produced in the same manner as the battery 6, except that the weight ratio R was varied as shown in Table 1 by changing the weights of active materials of the positive electrode and the negative electrode.

For comparison, a battery A of Comparative Example was produced in the same manner as the battery 6, except that LiCoO₂ was used as the positive electrode active material.

### (Battery Evaluation)

The batteries 1 to 9 and the battery A of Comparative Example thus produced were subjected to 500 charge/discharge cycles at an ambient temperature of 20° C. With respect to the charge, they were charged at a maximum current of 600 mA and a constant voltage of 4.25 V, 4.4 V, or 4.5 V for 2 hours. The discharge was performed at a constant current of 600 mA until the voltage dropped to 3.0 V. After 500 cycles, the discharge capacity was measured, and the ratio of the discharge capacity to the initial capacity (capacity at the 2nd cycle) was evaluated.

Also, after the measurement of the initial capacity, the batteries were charged at a constant voltage of 4.2 V, 4.25 V, 4.4 V, or 4.5 V for 2 hours, and the batteries were then heated in a temperature-controlled oven at 5° C./min to measure the limit temperature at which heat runaway resulted (referred to as heat runaway limit temperature).

Table 1 shows the positive/negative active material weight ratios R for the respective batteries of Examples and Comparative Example. Table 2 shows the capacity retention rates after 500 cycles and the heat runaway limit temperatures obtained in the heating test for each of the set cut-off voltages of charge.

TABLE 1

| | | | Active | |
|---|---|---|---|---|
| | | | material weight | |
| | | | (mg/cm²) | |
| | Positive electrode active | Weight | Positive | Negative |
| | material | ratio R | electrode | electrode |
| Battery 1 | LiCo_{0.94}Mg_{0.05}Al_{0.01}O₂ | 1.20 | 18.8 | 15.7 |
| Battery 2 | LiCo_{0.94}Mg_{0.05}Al_{0.01}O₂ | 1.30 | 19.3 | 14.8 |
| Battery 3 | LiCo_{0.94}Mg_{0.05}Al_{0.01}O₂ | 1.40 | 19.8 | 14.1 |
| Battery 4 | LiCo_{0.94}Mg_{0.05}Al_{0.01}O₂ | 1.50 | 20.3 | 13.5 |
| Battery 5 | LiCo_{0.94}Mg_{0.05}Al_{0.01}O₂ | 1.70 | 21.3 | 12.5 |
| Battery 6 | LiCo_{0.94}Mg_{0.05}Al_{0.01}O₂ | 2.00 | 22.8 | 11.4 |
| Battery 7 | LiCo_{0.94}Mg_{0.05}Al_{0.01}O₂ | 2.20 | 23.7 | 10.8 |
| Battery 8 | LiCo_{0.94}Mg_{0.05}Al_{0.01}O₂ | 2.30 | 24.3 | 10.6 |
| Battery 9 | LiCo_{0.94}Mg_{0.05}Al_{0.01}O₂ | 2.40 | 24.8 | 10.3 |
| Comparison | LiCoO₂ | 2.00 | 22.8 | 11.4 |
| A | | | | |

TABLE 2

| | | | | Heat runaway limit | | | |
|---|---|---|---|---|---|---|---|
| | Capacity retention | | | temperature (° C.) | | | |
| | rate (%) | | | 4.20 | 4.25 | 4.40 | 4.50 |
| | 4.25 V | 4.40 V | 4.50 V | V | V | V | V |
| Battery 1 | 76 | 73 | 70 | 160 | 154 | 152 | 150 |
| Battery 2 | 78 | 74 | 73 | 166 | 162 | 160 | 155 |
| Battery 3 | 79 | 76 | 74 | 170 | 166 | 164 | 160 |
| Battery 4 | 80 | 82 | 80 | 175 | 173 | 172 | 170 |
| Battery 5 | 81 | 81 | 80 | 174 | 172 | 172 | 170 |
| Battery 6 | 80 | 77 | 75 | 174 | 173 | 171 | 171 |
| Battery 7 | 79 | 74 | 73 | 173 | 172 | 172 | 172 |
| Battery 8 | 70 | 64 | 59 | 170 | 162 | 160 | 155 |
| Battery 9 | 65 | 50 | 40 | 168 | 158 | 150 | 150 |
| Comparison A | 45 | 39 | 31 | 162 | 152 | 141 | 135 |

As shown in Table 2, the batteries 1 to 9 of Examples including LiCo_{0.94}Mg_{0.5}Al_{0.01}O₂ as the positive electrode active material exhibit good cycle characteristics, compared with the battery A of Comparative Example including LiCoO₂ as the positive electrode active material. They have high capacity retention rates particularly when the charge voltage was high.

Deteriorated batteries were disassembled and their positive electrodes were analyzed by X-ray diffraction. The results indicate that in the battery of Comparative Example, the crystal structure of the positive electrode active material changed in the final stage of cycling and that the positive electrode active material deteriorated significantly due to repeated charge/discharge at high voltage.

On the other hand, in the case of the batteries of Example including LiCo_{0.94}Mg_{0.05}Al_{0.01}O₂, their positive electrodes were analyzed by X-ray diffraction after 500 cycles. The results confirm that the original crystal structure of those positive electrode active materials was maintained and that the crystal structure was stable even after repeated charge/discharge at high voltage.

Also, the batteries 1 to 7, in which the positive/negative active material weight ratio R is 2.2 or less, exhibited better cycle characteristics than the batteries 8 and 9, in which the active material weight ratio R is greater than 2.2, even when the charge voltage was heightened. The batteries 8 and 9 were analyzed by X-ray diffraction in the same manner. The results indicate that there was no change in the crystal structure of the positive electrode active materials and no deterioration in the positive electrodes. However, with the positive/negative active material weight ratio R being 2.3 or more, the negative electrode weight is small, so the load of the negative electrode during charge is high and the negative electrode potential is constantly low. Thus, it was found that reductive decomposition products of the electrolyte accumulated, thereby interfering with the charge/discharge reactions. For this reason, it is believed that the resistance to lithium ion transfer increased, thereby resulting in a capacity decline after cycling.

The above results indicate that the batteries of the present invention exhibit high cycle characteristics even when the charge/discharge voltage is in the high range from 4.25 V to 4.5 V. Particularly, they demonstrate that the batteries in which the positive/negative active material weight ratio R is less than 2.2 can provide good cycle characteristics.

Next, the safety of batteries charged to high voltages is described.

As shown in Table 2, the battery of Comparative Example including LiCoO₂ as the positive electrode active material exhibited high stability when the charge voltage was 4.2 V, with the heat runaway limit temperature being 160° C. However, when the charge voltage was increased, the heat runaway limit temperature lowered significantly, which indicates that the battery safety is low. Contrary to this, the batteries 1 to 9 of this example including LiCo_{0.94}Mg_{0.05}Al_{0.01}O₂ as the positive electrode active material exhibited significantly high safety even when the charge voltage was 4.5 V, with the heat runaway limit temperature being 150° C. or more. This confirms that the addition of Mg and Al to the positive electrode active material is clearly effective.

Also, the batteries 4 to 7, in which the positive/negative active material weight ratio R is in the range from 1.5 or more and 2.2 or less, exhibited higher stability even when the charge voltage was increased to 4.5 V, with the heat runaway limit temperature being 170° C. or more, which is preferable.

In the case of the batteries in which the positive/negative active material weight ratio R is 1.4 or less, the proportion of the active material of the negative electrode is extremely high, compared with the positive electrode. Probably for this reason, the heat generated by the decomposition reaction between the negative electrode and the electrolyte affected the safety of the whole cell, thereby resulting in slight deterioration in safety. Particularly, the battery with the weight ratio R of 1.2 was not good.

The above results demonstrate that the batteries including the positive electrode active material of the present invention exhibit high safety even when the charge/discharge voltage is in the high voltage range from 4.25 V to 4.5 V. Particularly, they indicate that the batteries in which the weight ratio R per unit opposing area is 1.5 or more can provide higher safety.

The combined results of the above two tests show that by setting the positive/negative active material weight ratio R in the range from 1.3 to 2.2, a battery with a higher capacity can be realized. They indicate that the batteries with the weight ratio R being in the range from 1.5 to 2.2, in particular, are excellent and preferable in cycle characteristics and safety even when the charge voltage is as high as 4.25 to 4.5 V.

It should be noted that essentially the same results could be obtained when the additional element M was an element other than Mg and Al, for example, Ti, Mn, Ni, Zr, Mo, or W.

### EXAMPLE 2

Batteries 10 to 18 were produced in the same manner as in Example 1, except for the use of LiNi_{0.4}Mn_{0.4}Co_{0.2}O₂ as the positive electrode active material, and evaluated in the same manner as in Example 1. Table 3 shows the positive/negative active material weight ratios R.

Table 4 shows the capacity retention rates after 500 cycles and the heat runaway limit temperatures obtained in the heating test for each of the set cut-off voltages of charge.

TABLE 3

| | | | Active material | |
|---|---|---|---|---|
| | | | weight (mg/cm²) | |
| | Positive electrode | Weight | Positive | Negative |
| | active material | ratio R | electrode | electrode |
| Battery 10 | LiNi_{0.4}Mn_{0.4}Co_{0.2}O₂ | 1.20 | 18.8 | 15.7 |
| Battery 11 | LiNi_{0.4}Mn_{0.4}Co_{0.2}O₂ | 1.30 | 19.3 | 14.8 |
| Battery 12 | LiNi_{0.4}Mn_{0.4}Co_{0.2}O₂ | 1.40 | 19.8 | 14.1 |
| Battery 13 | LiNi_{0.4}Mn_{0.4}Co_{0.2}O₂ | 1.50 | 20.3 | 13.5 |
| Battery 14 | LiNi_{0.4}Mn_{0.4}Co_{0.2}O₂ | 1.70 | 21.3 | 12.5 |
| Battery 15 | LiNi_{0.4}Mn_{0.4}Co_{0.2}O₂ | 2.00 | 22.8 | 11.4 |
| Battery 16 | LiNi_{0.4}Mn_{0.4}Co_{0.2}O₂ | 2.20 | 23.7 | 10.8 |
| Battery 17 | LiNi_{0.4}Mn_{0.4}Co_{0.2}O₂ | 2.30 | 24.3 | 10.6 |
| Battery 18 | LiNi_{0.4}Mn_{0.4}Co_{0.2}O₂ | 2.40 | 24.8 | 10.3 |
| Comparison A | LiCoO₂ | 2.00 | 22.8 | 11.4 |

TABLE 4

| | | | | Heat runaway limit | | | |
|---|---|---|---|---|---|---|---|
| | Capacity retention | | | temperature (° C.) | | | |
| | rate (%) | | | 4.20 | 4.25 | 4.40 | 4.50 |
| | 4.25 V | 4.40 V | 4.50 V | V | V | V | V |
| Battery 10 | 77 | 74 | 71 | 172 | 168 | 160 | 157 |
| Battery 11 | 77 | 76 | 74 | 171 | 170 | 170 | 168 |
| Battery 12 | 79 | 80 | 79 | 173 | 172 | 171 | 168 |
| Battery 13 | 80 | 80 | 80 | 174 | 171 | 168 | 169 |
| Battery 14 | 80 | 80 | 80 | 172 | 170 | 169 | 169 |
| Battery 15 | 77 | 74 | 73 | 172 | 171 | 170 | 171 |
| Battery 16 | 76 | 74 | 70 | 170 | 161 | 158 | 153 |
| Battery 17 | 68 | 68 | 61 | 167 | 156 | 149 | 148 |
| Battery 18 | 64 | 53 | 41 | 163 | 159 | 149 | 152 |
| Comparison A | 45 | 39 | 31 | 162 | 152 | 141 | 135 |

In the same manner as in Example 1, the batteries 11 to 16 including the positive electrode active material of the present invention exhibited excellent cycle characteristics and safety. In particular, the batteries 11 to 15, in which the positive/negative active material weight ratio R is in the range from 1.3 to 2.0, exhibited excellent cycle characteristics and safety even when the charge voltage was as high as 4.25 to 4.5 V, and they were found to be particularly preferable.

It should be noted that essentially the same results could be obtained even when the additional element M is an element other than Co, namely Mg, Al, Ti, Zr, Mo, or W.

### EXAMPLE 3

Batteries 19 to 27 having the positive/negative active material weight ratios R as shown in Table 5 were produced in the same manner as in Example 1, except for the use of a mixture of LiCo_{0.94}Mg_{0.05}Al_{0.01}O₂ and LiNi_{0.4}Mn_{0.4}Co_{0.2}O₂ in a weight ratio of 70:30 as the positive electrode active material. They were evaluated in the same manner as in Example 1.

Table 6 shows the capacity retention rates after 500 cycles and the heat runaway limit temperatures obtained in the heating test for each of the set cut-off voltages of charge.

TABLE 5

| | | | Active material | |
|---|---|---|---|---|
| | | | weight | |
| | Positive electrode active | | (mg/cm²) | |
| | material | Weight | Positive | Negative |
| | (Weight ratio) | ratio R | electrode | electrode |
| Battery | LiCo_{0.94}Mg_{0.05}Al_{0.01}O₂/ | 1.20 | 18.8 | 15.7 |
| 19 | LiNi_{0.4}Mn_{0.4}Co_{0.2}O₂(70/30) | | | |
| Battery | LiCo_{0.94}Mg_{0.05}Al_{0.01}O₂/ | 1.30 | 19.3 | 14.8 |
| 20 | LiNi_{0.4}Mn_{0.4}Co_{0.2}O₂(70/30) | | | |
| Battery | LiCo_{0.94}Mg_{0.05}Al_{0.01}O₂/ | 1.40 | 19.8 | 14.1 |
| 21 | LiNi_{0.4}Mn_{0.4}Co_{0.2}O₂(70/30) | | | |
| Battery | LiCo_{0.94}Mg_{0.05}Al_{0.01}O₂/ | 1.50 | 20.3 | 13.5 |
| 22 | LiNi_{0.4}Mn_{0.4}Co_{0.2}O₂(70/30) | | | |
| Battery | LiCo_{0.94}Mg_{0.05}Al_{0.01}O₂/ | 1.70 | 21.3 | 12.5 |
| 23 | LiNi_{0.4}Mn_{0.4}Co_{0.2}O₂(70/30) | | | |
| Battery | LiCo_{0.94}Mg_{0.05}Al_{0.01}O₂/ | 2.00 | 22.8 | 11.4 |
| 24 | LiNi_{0.4}Mn_{0.4}Co_{0.2}O₂(70/30) | | | |
| Battery | LiCo_{0.94}Mg_{0.05}Al_{0.01}O₂/ | 2.20 | 23.7 | 10.8 |
| 25 | LiNi_{0.4}Mn_{0.4}Co_{0.2}O₂(70/30) | | | |
| Battery | LiCo_{0.94}Mg_{0.05}Al_{0.01}O₂/ | 2.30 | 24.3 | 10.6 |
| 26 | LiNi_{0.4}Mn_{0.4}Co_{0.2}O₂(70/30) | | | |
| Battery | LiCo_{0.94}Mg_{0.05}Al_{0.01}O₂/ | 2.40 | 24.8 | 10.3 |
| 27 | LiNi_{0.4}Mn_{0.4}Co_{0.2}O₂(70/30) | | | |
| Compari- | LiCoO₂ | 2.00 | 22.8 | 11.4 |
| son A | | | | |

TABLE 6

| | | | | Heat runaway limit | | | |
|---|---|---|---|---|---|---|---|
| | Capacity retention | | | temperature (° C.) | | | |
| | rate (%) | | | 4.20 | 4.25 | 4.40 | 4.50 |
| | 4.25 V | 4.40 V | 4.50 V | V | V | V | V |
| Battery 19 | 78 | 75 | 72 | 173 | 165 | 160 | 158 |
| Battery 20 | 78 | 77 | 75 | 172 | 171 | 172 | 169 |
| Battery 21 | 80 | 81 | 80 | 172 | 171 | 171 | 168 |
| Battery 22 | 81 | 80 | 80 | 173 | 172 | 172 | 169 |
| Battery 23 | 84 | 82 | 82 | 172 | 171 | 171 | 170 |
| Battery 24 | 83 | 82 | 82 | 171 | 172 | 172 | 171 |
| Battery 25 | 79 | 77 | 72 | 171 | 170 | 169 | 168 |
| Battery 26 | 67 | 67 | 63 | 166 | 157 | 148 | 147 |
| Battery 27 | 63 | 54 | 40 | 164 | 158 | 148 | 150 |
| Comparison A | 45 | 39 | 31 | 162 | 152 | 141 | 135 |

The batteries 20 to 25 of the present invention exhibited excellent cycle characteristics and safety, thereby demonstrating that they have excellent cycle characteristics and safety even when the charge voltage is as high as 4.25 to 4.5 V. Also, their cycle characteristics at high voltages were generally superior to those in Example 1.

### EXAMPLE 4

Batteries 28 to 37 were produced in the same manner as in Example 1, except that LiCo_{0.94}Mg_{0.05}Al_{0.01}O₂ and LiNi_{0.4}Mn_{0.4}Co_{0.2}O₂ were mixed as the positive electrode active materials in the weight ratios as shown in Table 7 and that the positive/negative active material weight ratio R was set to 2.0. They were evaluated for discharge capacity and low-temperature discharge characteristics. With respect to the discharge capacity, they were charged at a maximum current of 600 mA and a constant voltage of 4.25 V, 4.4 V, or 4.5 V in an ambient temperature of 20° C. for 2 hours and discharged at a current of 600 mA until the voltage dropped to 3.0 V, whereby their discharge capacities were measured. The discharge capacity was expressed as a percentage relative to the discharge capacity of the battery 28 charged at 4.25 V, which was defined as 100. With respect to the low-temperature discharge characteristics, in ambient temperatures 20° C. and −10° C., charge and discharge were performed under the same conditions as those described above, to obtain discharge capacity. The percentage of the discharge capacity at −10° C. relative to the discharge capacity at 20° C. was shown.

Table 8 shows the percentages of the discharge capacities of the respective batteries and the percentages of the low-temperature discharge capacities for each of the set cut-off voltages of charge.

TABLE 7

| | | | | Active material | |
|---|---|---|---|---|---|
| | | | | weight | |
| | | | | (mg/cm²) | |
| | | | | | Neg- |
| | Positive electrode | | | | ative |
| | Positive electrode | Weight | Weight | Positive | elec- |
| | active material | ratio | ratio R | electrode | trode |
| Battery | LiCo_{0.94}Mg_{0.05}Al_{0.01}O₂/ | 95/5 | 2.00 | 22.8 | 11.4 |
| 28 | LiNi_{0.4}Mn_{0.4}Co_{0.2}O₂ | | | | |
| Battery | LiCo_{0.94}Mg_{0.05}Al_{0.01}O₂/ | 90/10 | 2.00 | 22.8 | 11.4 |
| 29 | LiNi_{0.4}Mn_{0.4}Co_{0.2}O₂ | | | | |
| Battery | LiCo_{0.94}Mg_{0.05}Al_{0.01}O₂/ | 80/20 | 2.00 | 22.8 | 11.4 |
| 30 | LiNi_{0.4}Mn_{0.4}Co_{0.2}O₂ | | | | |
| Battery | LiCo_{0.94}Mg_{0.05}Al_{0.01}O₂/ | 70/30 | 2.00 | 22.8 | 11.4 |
| 24 | LiNi_{0.4}Mn_{0.4}Co_{0.2}O₂ | | | | |
| Battery | LiCo_{0.94}Mg_{0.05}Al_{0.01}O₂/ | 60/40 | 2.00 | 22.8 | 11.4 |
| 31 | LiNi_{0.4}Mn_{0.4}Co_{0.2}O₂ | | | | |
| Battery | LiCo_{0.94}Mg_{0.05}Al_{0.01}O₂/ | 50/50 | 2.00 | 22.8 | 11.4 |
| 32 | LiNi_{0.4}Mn_{0.4}Co_{0.2}O₂ | | | | |
| Battery | LiCo_{0.94}Mg_{0.05}Al_{0.01}O₂/ | 40/60 | 2.00 | 22.8 | 11.4 |
| 33 | LiNi_{0.4}Mn_{0.4}Co_{0.2}O₂ | | | | |
| Battery | LiCo_{0.94}Mg_{0.05}Al_{0.01}O₂/ | 30/70 | 2.00 | 22.8 | 11.4 |
| 34 | LiNi_{0.4}Mn_{0.4}Co_{0.2}O₂ | | | | |
| Battery | LiCo_{0.94}Mg_{0.05}Al_{0.01}O₂/ | 20/80 | 2.00 | 22.8 | 11.4 |
| 35 | LiNi_{0.4}Mn_{0.4}Co_{0.2}O₂ | | | | |
| Battery | LiCo_{0.94}Mg_{0.05}Al_{0.01}O₂/ | 10/90 | 2.00 | 22.8 | 11.4 |
| 36 | LiNi_{0.4}Mn_{0.4}Co_{0.2}O₂ | | | | |
| Battery | LiCo_{0.94}Mg_{0.05}Al_{0.01}O₂/ | 5/95 | 2.00 | 22.8 | 11.4 |
| 37 | LiNi_{0.4}Mn_{0.4}Co_{0.2}O₂ | | | | |

TABLE 8

| | Percentage of | | | Percentage of | | |
|---|---|---|---|---|---|---|
| | discharge capacity | | | low-temperature | | |
| | (%) | | | discharge (%) | | |
| | 4.25 V | 4.40 V | 4.50 V | 4.25 V | 4.40 V | 4.50 V |
| Battery 28 | 100.0 | 101.0 | 103.0 | 82 | 80 | 79 |
| Battery 29 | 100.3 | 105.0 | 107.2 | 82 | 80 | 79 |
| Battery 30 | 100.5 | 105.4 | 107.5 | 81 | 79 | 79 |
| Battery 24 | 100.9 | 105.6 | 107.9 | 80 | 79 | 78 |
| Battery 31 | 101.0 | 106.2 | 108.0 | 80 | 79 | 78 |
| Battery 32 | 101.1 | 106.3 | 108.1 | 79 | 78 | 78 |
| Battery 33 | 101.2 | 106.4 | 108.1 | 72 | 71 | 70 |
| Battery 34 | 101.3 | 106.5 | 108.2 | 72 | 71 | 70 |
| Battery 35 | 101.4 | 106.7 | 108.3 | 71 | 70 | 69 |
| Battery 36 | 101.6 | 106.8 | 108.4 | 70 | 70 | 68 |
| Battery 37 | 101.6 | 106.8 | 108.4 | 52 | 50 | 48 |

The percentage of discharge capacity becomes higher as the ratio of LiNi_{0.4}Mn_{0.4}Co_{0.2}O₂ to the mixture of the positive electrode active materials becomes higher. Particularly at high voltages of 4.4 V and 4.5 V, the batteries 29 to 37 and the battery 24, in which the ratio of LiNi_{0.4}Mn_{0.4}Co_{0.2}O₂ is 10% by weight or more, exhibit large increases in discharge capacity. This is probably for the following two reasons. First, LiNi_{0.4}Mn_{0.4}Co_{0.2}O₂ has a higher capacity per unit weight. Second, mixing LiCu_{0.94}Mg_{0.05}Al_{0.01}O₂ with a relatively small irreversible capacity and LiNi_{0.4}Mn_{0.4}Co_{0.2}O₂ with a relatively large irreversible capacity resulted in a reduction in the difference in irreversible capacity between the positive and negative electrodes.

The batteries 28 to 36 and the battery 24, in which the weight ratio between the two kinds of positive electrode active materials is from 95/5 to 10/90, exhibited improvements in low-temperature discharge characteristics. Also, at high voltages of 4.40 V and 4.50 V, the batteries 28 to 32 and the battery 24, in which the positive/negative active material weight ratio is from 95/5 to 50/50, exhibited excellent low temperature characteristics. This is probably because LiCo_{0.94}Mg_{0.05}Al_{0.01}O₂ has excellent electronic conductivity.

The above results clearly demonstrate that the use of a mixture of LiCo_{0.94}Mg_{0.05}Al_{0.01}O₂ and LiNi_{0.4}Mn_{0.4}Co_{0.2}O₂ in a weight ratio from 90/10 to 10/90, preferably from 90/10 to 50/50 makes it possible to realize a battery having a higher capacity and excellent low-temperature discharge characteristics.

### EXAMPLE 5

A battery 38 was produced in the same manner as the battery 6 of Example 1, except for the addition of 1.0 part by weight of cyclohexyl benzene per 100 parts by weight of the electrolyte. This battery 38 and the battery 6 were subjected to an overcharge test. The overcharge test was conducted by preparing 10 cells in a discharged state, charging them continuously at a maximum current of 600 mA for 5 hours, and comparing the number of cells that caused heat runaway.

As a result, in the case of the battery 6, 3 cells out of 10 cells caused heat runaway, whereas in the case of the battery 38, all 10 cells did not cause heat runaway. The result shows that cyclohexyl benzene, which is reported to be effective in overcharge tests when used in batteries of the conventional 4.2 V-based design, is also effective upon overcharge when used in batteries of a higher voltage design. Further, biphenyl and diphenyl ether also produced essentially the same effects as in the battery 38.

### EXAMPLE 6

Batteries 39 to 50 were produced in the same manner as in the battery 6 of Example 1, except for the use of electrolytes dissolving therein LiPF₆ and LiBF₄ at the concentrations as shown in Table 9, and evaluated for cycle characteristics.

Table 9 shows the capacity retention rates after 500 cycles for each of the set cut-off voltages of charge.

TABLE 9

| | | Capacity retention | | |
|---|---|---|---|---|
| | LiPF₆/LiBF₄ | rate(%) | | |
| | (Unit: mol/l) | 4.25 V | 4.40 V | 4.50 V |
| Battery 39 | 0.4/0.0 | 50 | 43 | 41 |
| Battery 40 | 0.5/0.0 | 71 | 70 | 70 |
| Battery 41 | 0.6/0.0 | 75 | 74 | 74 |
| Battery 42 | 1.9/0.0 | 77 | 75 | 74 |
| Battery 43 | 2.0/0.0 | 75 | 74 | 73 |
| Battery 44 | 2.1/0.0 | 61 | 58 | 55 |
| Battery 45 | 1.0/0.005 | 80 | 77 | 75 |
| Battery 46 | 1.0/0.01 | 85 | 84 | 84 |
| Battery 47 | 1.0/0.05 | 86 | 85 | 85 |
| Battery 48 | 1.0/0.2 | 85 | 85 | 84 |
| Battery 49 | 1.0/0.3 | 84 | 84 | 83 |
| Battery 50 | 1.0/0.4 | 80 | 78 | 73 |

The batteries 40 to 43 with LiPF₆ concentrations of 0.5 to 2.0 mol/l exhibited excellent cycle characteristics in the same manner as the battery 6. However, the battery 39 with a concentration of 0.4 mol/l exhibited a decrease in cycle retention rate. This is probably because the decomposition of the LiPF₆ due to cycling caused a lithium salt shortage after 500 cycles, thereby making normal discharge impossible. Further, the battery 44 with a concentration of 2.1 mol/l also exhibited a decrease, probably because the excessively high concentration increased the viscosity of the electrolyte, thereby interfering with the smooth penetration of the electrolyte into the electrode plates.

On the other hand, the batteries 46 to 49 including LiPF₆ and LiBF₄ in combination exhibited further improvements in cycle characteristics. Although this mechanism is not yet clear, it is probably due to the action of LiBF₄ to suppress the decomposition of the electrolyte during cycling. However, the effect of LiBF₄ was not observed in the battery 45 with a LiBF₄ concentration of 0.005 mol/l, and a degradation of cycle characteristics was observed in the battery 50 with a concentration of 0.4 mol/l.

These results clearly show that when the LiPF₆ concentration is 0.5 to 2.0 mol/l, good cycle characteristics can be obtained and that the addition of LiBF₄ at 0.01 to 0.3 mol/l further improves cycle characteristics.

### EXAMPLE 7

Batteries 51 to 59 were produced in the same manner as the battery 6 of Example 1, except for the use of electrolytes prepared by using solvents as shown in Table 10, and evaluated in the same manner as in Example 1.

Table 11 shows the capacity retention rates after 500 cycles and the heat runaway limit temperatures obtained in the heating test for each of the set cut-off voltages of charge.

TABLE 10

| | Solvent |
|---|---|
| | (Volume ratio) |
| Battery 51 | EC/DEC(30/70) |
| Battery 52 | EC/DMC(30/70) |
| Battery 53 | EC/EMC/DEC(30/40/30) |
| Battery 54 | EC/EMC(5/95) |
| Battery 55 | EC/EMC(10/90) |
| Battery 56 | EC/EMC(20/90) |
| Battery 57 | EC/EMC(40/60) |
| Battery 58 | EC/EMC(50/50) |
| Battery 59 | EC/EMC(60/40) |

TABLE 11

| | | | | Heat runaway limit | | | |
|---|---|---|---|---|---|---|---|
| | Capacity retention | | | temperature (° C.) | | | |
| | rate (%) | | | | | 4.40 | 4.50 |
| | 4.25 V | 4.40 V | 4.50 V | 4.20 V | 4.25 V | V | V |
| Battery 51 | 78 | 71 | 69 | 188 | 185 | 184 | 183 |
| Battery 52 | 80 | 78 | 75 | 173 | 172 | 170 | 170 |
| Battery 53 | 80 | 76 | 76 | 186 | 183 | 182 | 181 |
| Battery 54 | 60 | 51 | 45 | 168 | 166 | 164 | 164 |
| Battery 55 | 77 | 72 | 71 | 173 | 172 | 171 | 170 |
| Battery 56 | 80 | 75 | 73 | 174 | 172 | 171 | 171 |
| Battery 57 | 80 | 77 | 74 | 175 | 174 | 173 | 172 |
| Battery 58 | 79 | 76 | 75 | 175 | 173 | 173 | 172 |
| Battery 59 | 70 | 58 | 50 | 174 | 171 | 170 | 169 |

The battery 51 including ethylene carbonate (EC)/diethyl carbonate (DEC) in a volume mixing ratio of 30/70 as the solvent produced good results of high heat runaway limit temperatures, although a slight degradation of cycle characteristics was observed. The battery 52 including EC/dimethyl carbonate (DMC) in a volume mixing ratio of 30/70 produced excellent results equivalent to those of the battery 6. Further, the battery 53 including EC/ethyl methyl carbonate (EMC)/DEC in a volume mixing ratio of 30/40/30 maintained excellent cycle characteristics equivalent to those of the battery 6, and exhibited excellent heat runaway limit temperatures equivalent to those of the battery 51. This clearly indicates that the use of EMC and DEC in combination can provide excellent characteristics. Also, in an electrolyte containing EC, EMC, and DEC, when the content of EC is 10 to 50% by volume of the whole solvent, the content of EMC is 20 to 60% by volume, and the content of DEC is 10 to 50% by volume, it was possible to obtain excellent cycle characteristics and excellent heat runaway limit temperature equivalent to those of the battery 53.

Further, the batteries 55 to 58 with EC contents of 10 to 50% by volume exhibited excellent characteristics equivalent to those of the battery 6. However, the battery 54 with a small EC content exhibited decreases in both cycle characteristics and heat runaway limit temperature. The battery 59 with a high EC content exhibited degradation of cycle characteristics. The reason is probably as follows. When the EC content is low, the amount of a good coating film formed on the negative electrode due to decomposition of part of EC decreases, so that the reactivity between the negative electrode and the electrolyte increases, thereby promoting the decomposition of the electrolyte during the cycling and increasing the amount of heat generated by the reaction between the negative electrode and the electrolyte in the heating test. On the other hand, when the EC content is high, the viscosity of the electrolyte increases, thereby interfering with the smooth penetration of the electrolyte into the electrode plates.

### EXAMPLE 8

Batteries 60 to 79 were produced in the same manner as the battery 6 of Example 1, except for the use of LiCo_{0.94}Mg_{0.05}Al_{0.01}O₂ coated with a material as shown in Table 12 as the positive electrode active material, and evaluated for cycle characteristics.

The active material surface was coated with a material by mixing 3 parts by weight of a coating material with a mean particle size of 10 μm with 100 parts by weight of LiCo_{0.94}Mg_{0.05}Al_{0.01}O₂ and stirring them in an Ar atmosphere in a ball mill for 20 hours.

Table 12 shows the capacity retention rates after 500 cycles for each of the set cut-off voltages of charge.

TABLE 12

| | | Capacity retention | | |
|---|---|---|---|---|
| | | rate(%) | | |
| | Coating material | 4.25 V | 4.40 V | 4.50 V |
| Battery 60 | Mg | 83 | 82 | 82 |
| Battery 61 | Al | 83 | 83 | 82 |
| Battery 62 | Ti | 84 | 83 | 81 |
| Battery 63 | Sr | 83 | 82 | 81 |
| Battery 64 | Mn | 83 | 81 | 81 |
| Battery 65 | Ni | 84 | 80 | 80 |
| Battery 66 | Ca | 82 | 82 | 80 |
| Battery 67 | Zr | 83 | 83 | 81 |
| Battery 68 | Mo | 84 | 83 | 81 |
| Battery 69 | W | 83 | 81 | 80 |
| Battery 70 | Sn | 82 | 80 | 80 |
| Battery 71 | Si | 83 | 82 | 81 |
| Battery 72 | MgOx(0.4 ≦ x ≦ 2.0) | 83 | 83 | 81 |
| Battery 73 | AlOx(0.4 ≦ x ≦ 2.0) | 82 | 81 | 80 |
| Battery 74 | TiOx(0.4 ≦ x ≦ 2.0) | 83 | 82 | 81 |
| Battery 75 | MnOx(0.4 ≦ x ≦ 2.0) | 84 | 82 | 81 |
| Battery 76 | NiOx(0.4 ≦ x ≦ 2.0) | 83 | 82 | 82 |
| Battery 77 | ZrOx(0.4 ≦ x ≦ 2.0) | 84 | 83 | 81 |
| Battery 78 | MoOx(0.4 ≦ x ≦ 2.0) | 83 | 80 | 80 |
| Battery 79 | WOx(0.4 ≦ x ≦ 2.0) | 84 | 82 | 81 |

The batteries 60 to 79 including the positive electrode active materials coated with the materials exhibited improvements in a cycle retention rate, compared with the battery 6 including the uncoated active material. This is probably because the coating material prevented the dissolution of metal from the positive electrode active material in a high-voltage charged state, thereby suppressing the deterioration of the positive electrode active material due to cycling and improving the cycle retention rate.

### EXAMPLE 9

Batteries 80 to 87 were produced in the same manner as the battery 6 of Example 1, except that a metal oxide as shown in Table 13 was mixed with LiCo_{0.94}Mg_{0.05}Al_{0.01}O₂ as the positive electrode active material in preparing a positive electrode plate, and evaluated for cycle characteristics. Therein, 1 part by weight of a metal oxide was mixed with 100 parts by weight of LiCo_{0.94}Mg_{0.05}Al_{0.01}O₂ in stirring and mixing a positive electrode mixture.

Table 13 shows the capacity retention rates after 500 cycles for each of the set cut-off voltages of charge.

TABLE 13

| | | Capacity retention | | |
|---|---|---|---|---|
| | | rate(%) | | |
| | Material | 4.25 V | 4.40 V | 4.50 V |
| Battery 80 | MgOx(0.4 ≦ x ≦ 2.0) | 84 | 83 | 82 |
| Battery 81 | AlOx(0.4 ≦ x ≦ 2.0) | 83 | 83 | 82 |
| Battery 82 | TiOx(0.4 ≦ x ≦ 2.0) | 84 | 82 | 81 |
| Battery 83 | MnOx(0.4 ≦ x ≦ 2.0) | 83 | 82 | 81 |
| Battery 84 | NiOx(0.4 ≦ x ≦ 2.0) | 84 | 82 | 80 |
| Battery 85 | ZrOx(0.4 ≦ x ≦ 2.0) | 83 | 83 | 81 |
| Battery 86 | MoOx(0.4 ≦ x ≦ 2.0) | 82 | 82 | 81 |
| Battery 87 | WOx(0.4 ≦ x ≦ 2.0) | 83 | 82 | 82 |

The batteries 80 to 87 including the various metal oxides in their positive electrodes exhibited improvements in cycle retention rate, as compared with the battery 6 including the positive electrode plate including no metal oxide. This is probably because the oxide included in the positive electrode plate prevented the dissolution of metal from the positive electrode active material in a high-voltage charged state, thereby suppressing the deterioration of the positive electrode active material due to cycling and improving the capacity retention rate.

### EXAMPLE 10

A battery 88 was produced in the same manner as the battery 6 of Example 1, except that a mixture of SiO with a mean particle size of 5 μm and flake graphite in a weight ratio of 90:10 was used as the negative electrode active material at the positive/negative active material weight ratio R as shown in Table 14. Also, a battery B of Comparative Example was produced in the same manner as the battery A of Comparative Example prepared in Example 1, except that the same negative electrode active material as that of the battery 88 was used at the weight ratio R as shown in Table 14. The battery 88 and the batteries A and B of Comparative Example were evaluated for percentage of discharge capacity density, average discharge voltage, and cycle characteristics.

The respective batteries were charged at a maximum current of 600 mA and a constant voltage of 4.20 V, 4.25 V, 4.4 V, or 4.5 V at an ambient temperature of 20° C. for 2 hours, and discharged at a constant current of 600 mA until the voltage dropped to 3.0 V, whereby their discharge capacities were measured. The percentage of discharge capacity density was obtained by converting the above-mentioned discharge capacity to a discharge capacity per unit weight of the total weight of the positive and negative electrode active materials, and expressing it as a percentage relative to the discharge capacity density at 4.2 V of the battery A of Comparative Example, which was defined as 100. With respect to the average discharge voltage, charge and discharge were performed at an ambient temperature of 20° C. under the above-mentioned conditions and the average discharge voltage was measured.

Table 15 shows the percentages of discharge capacity density and the average discharge voltages for each of the set voltages. Table 16 shows the capacity retention rates after 500 cycles for each of the set cut-off voltages of charge.

TABLE 14

| | | Negative | | Active material weight | | |
|---|---|---|---|---|---|---|
| | Positive | electrode active | | (mg/cm²) | | |
| | electrode active | material | Weight | Positive | Negative | |
| | material | (Weight ratio) | ratio R | electrode | electrode | Total |
| Battery 88 | LiCo_{0.94}Mg_{0.05}Al_{0.01}O₂ | SiO/Flake | 3.5 | 22.8 | 6.5 | 29.3 |
| | | graphite (90/10) | | | | |
| Comparison A | LiCoO₂ | Flake graphite | 2.0 | 13.0 | 6.5 | 19.5 |
| | | (100) | | | | |
| Comparison B | LiCoO₂ | SiO/Flake | 3.5 | 22.8 | 6.5 | 29.3 |
| | | graphite (90/10) | | | | |

TABLE 15

| | Percentage of discharge | | | | | | | |
|---|---|---|---|---|---|---|---|---|
| | capacity density | | | | Average discharge voltage (V) | | | |
| | 4.20 V | 4.25 V | 4.40 V | 4.50 V | 4.20 V | 4.25 V | 4.40 V | 4.50 V |
| Battery 88 | 117 | 122 | 130 | 135 | 3.40 | 3.44 | 3.58 | 3.68 |
| Comparison A | 100 | 104 | 111 | 115 | 3.60 | 3.63 | 3.75 | 3.84 |
| Comparison B | 117 | 122 | 130 | 135 | 3.40 | 3.44 | 3.58 | 3.68 |

TABLE 16

| | Capacity retention | | |
|---|---|---|---|
| | rate(%) | | |
| | 4.25 V | 4.40 V | 4.50 V |
| Battery 88 | 80 | 76 | 74 |
| Comparison A | 45 | 39 | 31 |
| Comparison B | 44 | 36 | 31 |

Table 14 shows that the battery 88 and the battery B of Comparative Example, including the mixture of SiO and flake graphite in the weight ratio of 90:10 as the negative electrode active material, exhibit increases in discharge capacity of both positive and negative electrodes per active material weight, as compared with the battery A of Comparative Example including flake graphite as the negative electrode active material. This indicates that the use of a negative electrode active material made of or composed mainly of a metal compound can provide a battery with a high capacity. Further, the use of a high voltage such as 4.4 V or 4.5 V can provide a higher capacity. However, as is clear from Table 15, a battery including a negative electrode active material made of or composed mainly of a metal compound has a drawback in that the average discharge voltage is lower than that of a battery including a conventional negative electrode active material composed mainly of a carbonaceous substance. Thus, when such a battery including a negative electrode active material made of or composed mainly of a metal compound is incorporated into a device designed for a conventional cut-off voltage of charge of 4.2 V, the battery voltage drops significantly when a large current flows. As a result, a problem arises in that the discharge capacity is lower than the design capacity.

According to the present invention, by using a battery including a negative electrode active material made of or composed mainly of a metal compound at a high voltage such as 4.4 V or 4.5 V, it is possible to heighten the average discharge voltage to 3.6 to 3.7 V equivalent to that of batteries including a conventional negative electrode active material composed mainly of a carbonaceous substance. Also, when this battery is incorporated into a device, the device is prevented from failure due to voltage drop even when a large current flows, and the battery can provide a design discharge capacity.

Also, as is clear from Table 16, in the case of using a negative electrode active material made of or composed mainly of a metal compound, the battery B of Comparative Example including LiCoO₂ as the positive electrode active material has a low capacity retention rate after 500 cycles. However, the battery 88 including LiCo_{0.94}Mg_{0.5}Al_{0.01}O₂ as the positive electrode active material has a good capacity retention rate. The reason is the same as that as described in Example 1.

### EXAMPLE 11

Batteries 89 to 97 were produced in the same manner as in Example 1, except that a mixture of SiO with a mean particle size of 5 μm and flake graphite in a weight ratio of 90:10 was used as the negative electrode active material at the positive/negative active material weight ratios R as shown in Table 17, and evaluated in the same manner as Example 1.

Table 18 shows the capacity retention rates after 500 cycles and heat runaway limit temperatures in the heating test for each of the set cut-off voltages of charge.

TABLE 17

| | | Negative | | Active material weight | |
|---|---|---|---|---|---|
| | | electrode active | | (mg/cm²) | |
| | Positive electrode | material | Weight | Positive | Negative |
| | active material | (Weight ratio) | ratio R | electrode | electrode |
| Battery | LiCo_{0.94}Mg_{0.05}Al_{0.01}O₂ | SiO/Flake | 2.0 | 18.8 | 9.4 |
| 89 | | graphite (90/10) | | | |
| Battery | LiCo_{0.94}Mg_{0.05}Al_{0.01}O₂ | SiO/Flake | 2.5 | 19.3 | 7.7 |
| 90 | | graphite (90/10) | | | |
| Battery | LiCo_{0.94}Mg_{0.05}Al_{0.01}O₂ | SiO/Flake | 3.0 | 19.8 | 6.6 |
| 91 | | graphite (90/10) | | | |
| Battery | LiCo_{0.94}Mg_{0.05}Al_{0.01}O₂ | SiO/Flake | 5.0 | 20.3 | 4.1 |
| 92 | | graphite (90/10) | | | |
| Battery | LiCo_{0.94}Mg_{0.05}Al_{0.01}O₂ | SiO/Flake | 8.0 | 21.5 | 2.7 |
| 93 | | graphite (90/10) | | | |
| Battery | LiCo_{0.94}Mg_{0.05}Al_{0.01}O₂ | SiO/Flake | 14.0 | 22.8 | 1.6 |
| 94 | | graphite (90/10) | | | |
| Battery | LiCo_{0.94}Mg_{0.05}Al_{0.01}O₂ | SiO/Flake | 18.0 | 23.7 | 1.3 |
| 95 | | graphite (90/10) | | | |
| Battery | LiCo_{0.94}Mg_{0.05}Al_{0.01}O₂ | SiO/Flake | 19.0 | 24.3 | 1.3 |
| 96 | | graphite (90/10) | | | |
| Battery | LiCo_{0.94}Mg_{0.05}Al_{0.01}O₂ | SiO/Flake | 20.0 | 24.8 | 1.2 |
| 97 | | graphite (90/10) | | | |

TABLE 18

| | | | | Heat runaway limit | | | |
|---|---|---|---|---|---|---|---|
| | Capacity retention | | | temperature (° C.) | | | |
| | rate (%) | | | | | 4.40 | 4.50 |
| | 4.25 V | 4.40 V | 4.50 V | 4.20 V | 4.25 V | V | V |
| Battery 89 | 73 | 71 | 69 | 159 | 153 | 153 | 149 |
| Battery 90 | 77 | 72 | 72 | 167 | 163 | 160 | 156 |
| Battery 91 | 80 | 77 | 77 | 169 | 166 | 166 | 166 |
| Battery 92 | 79 | 79 | 78 | 174 | 172 | 170 | 170 |
| Battery 93 | 80 | 79 | 79 | 172 | 170 | 170 | 170 |
| Battery 94 | 79 | 77 | 76 | 174 | 173 | 171 | 170 |
| Battery 95 | 78 | 75 | 75 | 172 | 171 | 171 | 171 |
| Battery 96 | 78 | 75 | 74 | 171 | 168 | 168 | 167 |
| Battery 97 | 66 | 52 | 43 | 167 | 155 | 149 | 149 |

In the same manner as in Example 1, even when batteries include a negative electrode active material made of or composed mainly of a metal compound, the batteries 90 to 96 including the positive electrode active material of the present invention exhibited excellent cycle characteristics and safety.

Particularly, the batteries 91 to 96, in which the positive/negative active material weight ratio R is in the range from 3.0 to 19, exhibited excellent cycle characteristics and safety even when the voltage was as high as 4.25 to 4.5 V, thereby showing that they are particularly preferable. Also, the use of LiNi_{0.4}Mn_{0.4}Co_{0.2}O₂ as the positive electrode active material produced essentially the same results.

The use of a mixture of LiCo_{0.94}Mg_{0.5}Al_{0.01}O₂ and LiNi_{0.4}Mn_{0.4}Co_{0.2}O₂ in a weight ratio of 70:30 as the positive electrode active material also produced essentially the same results.

Oxides obtained by replacing the additional elements Mg and Al in LiCo_{0.94}Mg_{0.05}Al_{0.01}O₂ with Ti and W, Mn and Ni, or Zr and Mo, respectively, and oxides obtained by replacing the additional element Co in LiNi_{0.4}Mn_{0.4}Co_{0.2}O₂ with Mg, Al, Ti, Zr, Mo, or W also produced essentially the same results.

Further, the use of polytetrafluoroethylene as the positive electrode binder also produced essentially the same effects.

### INDUSTRIAL APPLICABILITY

The non-aqueous electrolyte secondary battery according to the present invention has excellent characteristics such as safety and cycle characteristics even when the cut-off voltage of charge in a normal operating condition is set to 4.25 V or more. Therefore, the non-aqueous electrolyte secondary battery of the present invention is useful as the main power source, particularly for mobile communications devices and portable electronic devices.

1. (canceled)

2. A non-aqueous electrolyte secondary battery comprising:
a negative electrode including an active material capable of absorbing and desorbing lithium;
a positive electrode including a lithium composite oxide as an active material;
a separator separating said negative electrode and said positive electrode; and
a lithium-ion conductive non-aqueous electrolyte,
said battery having a cut-off voltage of charge of 4.25 to 4.5 V,
wherein the active material of said negative electrode is composed mainly of a carbonaceous substance,
said lithium composite oxide comprises an oxide A represented by the formula LiₓCo_{1-y}M_{y}O₂ where M is at least one selected from the group consisting of Mg, Al, Ti, Sr, Mn, Ni, Ca, V, Fe, Y, Zr, Mo, Tc, Ru, Ta, W, Re, Yb, Cu, Zn, and Ba, 1.0≦x≦1.15, and 0.005≦y≦0.1 and an oxide B represented by the formula LiₓNi_{y}Mn_{z}M_{1-y-z}O₂ where M is at least one selected from the group consisting of Co, Mg, Al, Ti, Sr, Ca, V, Fe, Y, Zr, Mo, Tc, Ru, Ta, W, and Re, 1.0≦x≦1.15, 0.1≦y≦0.5, 0.1≦z≦0.5, and 0.9≦y/z≦3.0, and
in a region where said positive electrode and said negative electrode face each other, the Wp/Wn ratio R is in the range from 1.3 to 2.2 where Wp is the weight of the active material contained in said positive electrode per unit area and Wn is the weight of the active material contained in the negative electrode per unit area.

3-5. (canceled)

6. The non-aqueous electrolyte secondary battery in accordance with claim 2, wherein the weight ratio of said oxide A to said oxide B is from 9:1 to 1:9.

7. The non-aqueous electrolyte secondary battery in accordance with claim 2, wherein the weight ratio of said oxide A to said oxide B is from 9:1 to 5:5.

8. A non-aqueous electrolyte secondary battery comprising:
a negative electrode including an active material capable of absorbing and desorbing lithium;
a positive electrode including a lithium composite oxide as an active material;
a separator separating said negative electrode and said positive electrode; and
a lithium-ion conductive non-aqueous electrolyte,
said battery having a cut-off voltage of charge of 4.25 to 4.5 V,
wherein the active material of said negative electrode is composed mainly of an alloy or a metal compound,
said lithium composite oxide comprises an oxide A represented by the formula LiₓCo_{1-y}M_{y}O₂ where M is at least one selected from the group consisting of Mg, Al, Ti, Sr, Mn, Ni, Ca, V, Fe, Y, Zr, Mo, Tc, Ru, Ta, W, Re, Yb, Cu, Zn, and Ba, 1.0≦x≦1.15, and 0.005≦y≦0.1 and an oxide B represented by the formula LiₓNi_{y}Mn_{z}M_{1-y-z}O₂ where M is at least one selected from the group consisting of Co, Mg, Al, Ti, Sr, Ca, V, Fe, Y, Zr, Mo, Tc, Ru, Ta, W, and Re, 1.0≦x≦1.15, 0.1≦y≦0.5, 0.1≦z≦0.5, and 0.9≦y/z≦3.0, and
in a region where said positive electrode and said negative electrode face each other, the Wp/Wn ratio R is in the range from 2.5 to 19 where Wp is the weight of the active material contained in said positive electrode per unit area and Wn is the weight of the active material contained in the negative electrode per unit area.

9. The non-aqueous electrolyte secondary battery in accordance with claim 8, wherein the active material of said negative electrode is selected from the group consisting of Si, Sn, an alloy containing Si or Sn, and SiO.

10-12. (canceled)

13. The non-aqueous electrolyte secondary battery in accordance with claim 8, wherein the weight ratio of said oxide A to said oxide B is from 9:1 to 1:9.

14. The non-aqueous electrolyte secondary battery in accordance with claim 8, wherein the weight ratio of said oxide A to said oxide B is from 9:1 to 5:5.

15. The non-aqueous electrolyte secondary battery in accordance with claim 2, wherein a surface of said lithium composite oxide is coated with at least one metal selected from the group consisting of Mg, Al, Ti, Sr, Mn, Ni, Ca, V, Fe, Y, Zr, Mo, Tc, Ru, Ta, W, Re, Sn, Bi, Cu, Si, Ga, and B, an intermetallic compound containing said metal, or an oxide of said metal.

16. The non-aqueous electrolyte secondary battery in accordance with claim 2, wherein said positive electrode further comprises an oxide represented by the formula MOx where M is at least one selected from the group consisting of Li, Co, Mg, Al, Ti, Sr, Mn, Ni, Ca, V, Fe, Y, Zr, Mo, Tc, Ru, Ta, W, and Re, and 0.4≦x≦2.0.

17. The non-aqueous electrolyte secondary battery in accordance with claim 2, wherein said non-aqueous electrolyte contains a cyclic carbonate and a non-cyclic carbonate as solvents.

18. The non-aqueous electrolyte secondary battery in accordance with claim 17, wherein the volume ratio of said cyclic carbonate to the solvents of said non-aqueous electrolyte is 10 to 50% at 20° C.

19. The non-aqueous electrolyte secondary battery in accordance with claim 2, wherein said non-aqueous electrolyte contains LiPF₆ as a lithium salt.

20. The non-aqueous electrolyte secondary battery in accordance with claim 19, wherein said non-aqueous electrolyte contains 0.5 to 2.0 mol/l of LiPF₆ and 0.01 to 0.3 mol/l of LiBF₄ as lithium salts.

21. The non-aqueous electrolyte secondary battery in accordance with claim 2, wherein said non-aqueous electrolyte contains a cyclic carbonate and a non-cyclic carbonate as solvents, the volume ratio of said cyclic carbonate to the solvents of said non-aqueous electrolyte is 10 to 50%, and said non-aqueous electrolyte contains 0.5 to 2.0 mol/l of LiPF₆ and 0.01 to 0.3 mol/l of LiBF₄ as lithium salts.

22. The non-aqueous electrolyte secondary battery in accordance with claim 2, wherein said non-aqueous electrolyte contains, as an additive, at least one of benzene derivatives including a group that contains a phenyl group and tertiary or quaternary carbon adjacent to said phenyl group.

23. The non-aqueous electrolyte secondary battery in accordance with claim 22, wherein said additive is at least one selected from the group consisting of cyclohexyl benzene, biphenyl, and diphenyl ether, and the weight ratio of said additive to the non-aqueous electrolyte is 0.05 to 8.0%.

24. The non-aqueous electrolyte secondary battery in accordance with claim 23, wherein the weight ratio of said additive to the non-aqueous electrolyte is 0.1 to 6.0%.
